(19) United States
(12) Patent Application Publication
(10) Pub. No.: US 2012/0156469 A1
(43) Pub. Date: Jun. 21, 2012

(54) PROCESS FOR PRODUCING FLAMEPROOF (RIGID) PUR SPRAY FORMS

(75) Inventors: Stephan Schleiermacher, Pulheim (DE); Torsten Heinemann, Leichlingen (DE); Frithjof Hannig, Dusseldorf (DE); Roger Scholz, Doenrade (NL); Hans-Guido Wirtz, Leverkusen (DE); Heike Niederelz, Leverkusen (DE)

(73) Assignee: BAYER MATERIALSCIENCE AG, LEVERKUSEN (DE)

(21) Appl. No.: 13/392,232

(22) PCT Filed: Aug. 17, 2010
(86) PCT No.: PCT/EP10/05046

§ 371 Date: Mar. 7, 2012

(30) Foreign Application Priority Data
Aug. 26, 2009 (DE) 10 2009 038 821.4

(51) Int. Cl. E04B 1/74; C08L 75/04; B05D 1/02; C08J 9/228; B32B 5/20; B32B 5/14

(52) U.S. Cl. 428/310.5; 428/304.4; 427/427.6; 521/170; 521/99; 521/106; 521/128; 521/123; 521/122; 252/62

(57) ABSTRACT

The invention relates to a method for producing a flameproof polyurethane (PUR) spray foam, especially a rigid PUR spray foam, to a spray foam body so produced and to the use thereof for heat insulation.

The present invention relates to a process for producing a flameproof polyurethane (PUR) spray foam, especially a rigid PUR spray foam, a spray foam body thus produced, and the use thereof for heat insulation.

Foams have long been known and are widely employed because of their low density and the related saving of material, their excellent thermal and acoustic insulation properties, their mechanical damping, and their particular electric properties. Especially foams of polyurethane (PUR) are widely used. However, a distinction must be made between rigid and flexible foams. Because of their different cellular structures, they have different properties and are thus employed in different fields. Rigid foams within the meaning of the present invention are foams having a bulk density of from 30 to 100 kg/m³.

Rigid PUR foams are mainly employed for heat insulation, for example, in buildings, cooling devices, heat and cold storage systems as well as some pipe systems. The structure of the polymer, especially the closed cells of such a rigid foam, are the basis of the excellent insulating effect of this material.

The production methods for the various rigid foam applications differ. Thus, block foams can be produced continuously or discontinuously and then cut into sheets and mounted as an insulation material, for example, on exterior walls of houses.

When refrigerators or similar appliances are prepared, the polyurethane reaction mixture is directly placed into the cavity, where it reacts to form the insulation foam and thus fills the whole frame. Further, so-called metal composite panels, as used, for example, for erecting large warehouses, may also be prepared by inserting the polyurethane reaction mixture between two support panels (aluminum, sheet steel and/or wood). All these previously described rigid foam applications are based on the fact that rigid foam systems are used an insulation materials after being formed into a particular shape (as a block, in a refrigerator or in a metal composite).

However, there are also applications in which the insulating foam is directly applied to the surface to be insulated without a forming matrix. The spray foam method is such an application. In this method, the foam is frequently sprayed in several layers directly, for example, onto walls or ceilings of a building without a forming matrix being used or having to be used.

A flexible polyurethane foam and a flexible PUR molding foam are distinguished from an insulating rigid foam (whether shaped or sprayed) by a totally different cellular structure. Because of a skilful choice of the materials employed in the polyurethane system, the proportion of open cells is very much higher in flexible foams; in part, some of the remaining closed cells are disrupted mechanically (the so-called crushing) even after the production of the foams. Not only does this render the foam softer, it also gets some breathing activity, which is desirable in fields of application such as mattresses, (car) seats or pillows. This property is clearly different from the insulating property of a rigid foam, where such a gas exchange is not desirable.

For many applications, for example, in the construction field, it is necessary that the rigid foams meet requirements relating to their fire performance. Corresponding fire safety properties are frequently also demanded in legal regulations and in a number of other sets of rules. The proof that the construction materials meet the requirements of fire protection technology is provided by means of a wide variety of fire protection tests, which are usually directed to the application of the construction material.

Different construction materials supposed to improve fire protection have long been known from the prior art. Both DE 43 37 878 C2 and DE 195 39 681 C1 describe composite panels for fire protection. Such composite panels consist of an insulation layer and a fire protection layer or panel, the insulation layers of the individual panels being interconnected through tongue-and-groove joints.

DE 19 59 387 C3 includes a flame-retardant composite panel with a high heat and sound insulation property. The composite panel comprises a polyurethane foam layer foamed in place on a mineral perlite board.

Foams are also provided with flame-retardant agents in order to meet the requirements of fire protection technology. A frequently used flame-retardant solid is expandable graphite. It is known, for example, from GB A 1 404 822. A rigid polyurethane foam is foamed with a CFC foaming agent, wherein expandable graphite is homogeneously contained in the foamed body obtained. A flame-retardant polyurethane foam based on polyols and isocyanates with a flame-retardant agent is known from DE 197 02 760 A1. Such a polyurethane foam contains expandable graphite, for example. The polyol component has a phosphate fraction and a halogen fraction.

A combination of polyvinyl chloride particles and expandable graphite as admixtures with a rigid polyurethane foam is known from US 2008/0207784 A1. It describes polyvinyl chloride/polyurethane hybrid foams.

Other flame-retardant polymers, especially polyurethanes, are known from WO 2005/003254 A1 and JP 2002 144438 A. The flame-retardant materials, for example, expandable graphite, are mixed into at least one starting base material, so that the flame-retardant solid is homogeneously distributed in the final product.

A fireproof foam is known from WO 01/72863. A corresponding foam is provided with expandable graphite and does not contain any halogenated hydrocarbons as foaming agents. Expandable graphite is mixed together with polyol and/or isocyanate in a screw extruder.

It is further known from the prior art that different flame retardant agents can be mixed together. Thus, JP 2004 043747 A describes the use of expandable graphite together with phosphorus compounds in a polyurethane foam. The combination of expandable graphite with melamine cyanurate is known from RU 2336283 C2. Water or Freon® is additionally added as a foaming agent. A rigid foam containing a combination of expandable graphite and other flame retardant agents is also known from EP 1 159 341 B2. The flame retardant solids are uniformly contained in the rigid foam obtained.

A non-homogeneous distribution of flame retardants in polyurethane foam may be desirable because this may save material, namely the flame retardant solid. A product constituted of two layers is known from U.S. Pat. No. 4,254,177. The prefabricated core, which may consist of a rigid or flexible foam, does not contain any flame retardant substances. This core is surrounded by a coat having the desired flame retardant properties. The flame retardant materials are found only on the exterior side of the product. These are also the regions where flameproofing is needed. However, there is a drawback in the method described in that a core must be prepared first. Only this core can then be surrounded with the flame retardant coat. Thus, two process steps are possible in this process.

Polyurethane spray foams are frequently used in the construction of houses, but also in later renovations of buildings. Accordingly, such spray foams must also meet the corresponding fire protection standards.

Such spray foams, usually on the basis of a polyurethane, are sprayed onto the walls or ceilings to be insulated on site using a handy spraying unit. Both the exterior and the interior walls and ceilings of a building can be sprayed with such an insulating foam system. The two components required (isocyanate and polyol) are conveyed from the respective storage tanks through a hose system to the spraying unit. Such a spraying unit is usually a two-component mixing head as used in the polyurethane industry that additionally has a compressed air unit for forming the spray jet. After the application of the insulating layers, these are/may be clad with plaster or wall veneer parts.

When applied to the interior side (room side) of masonry, the foam is usually finally clad with plaster, or gypsum plaster boards, for example, are attached for cladding. On the exterior wall of a building, clinker bricks or comparable wall veneer parts are frequently applied to the PUR insulation layer. A corresponding wall will consist of a total of 5 material layers. From inside towards the outside, these are the plaster or gypsum plaster board, a spray foam layer, the masonry, an outer spray foam layer, and finally a wall veneer.

An insulating foam employed in this field must meet different requirements: In addition to a strong adhesion on the wall/ceiling, short reaction and setting times, various fire protection standards must also be met depending on the territory and place of application.

One fire protection standard that has to be met in many cases is “Euroclass E” (EN ISO 11925-2). To meet these required fire protection standards, different kinds of flame retardant agents and/or flame retardant components are used in practice in the formulations employed. Halogenated and/or phosphorus- or antimony-based compounds are often used as flame retardant agents employed, and further, various combinations of polyesters and p-aminocarbonyl compounds can be employed.

In particular, halogenated, often brominated, compounds are employed as flame retardant agents, because they are liquid. Thus, they can be admixed with the polyol or isocyanate component with no difficulty. However, there is a drawback in the use of such halogenated compounds in that they can evaporate from the insulation layer over an extended period of time. Thus, just when interior rooms are insulated, there is a load on health and environment that cannot be ignored.

It is also possible to replace the reactants (polyol and isocyanate) of the polyurethane at least partially by polyesters or β-aminocarbonyl compounds. The polyurethanes thus obtained have better flameproofing properties as compared to conventional polyurethanes.

Solids are also possible as further flame retardant agents in the field of such applications. For example, ammonium polyphosphate, melamine, glass flakes, expandable graphite, aluminum hydroxide, magnesium hydroxide, chalk, various cyanurates or other intumescent materials or compounds may be employed. Such compounds either are intumescent or release water, like aluminum hydroxide. Glass flakes melt under the action of the heat and form an inorganic protective layer on the surface of the polyurethane.

However, such flame retarding solids are significantly more difficult to process. As a rule, they are incorporated in the reaction mixture through one of the two components (polyol or isocyanate), like the liquid additives (batch process). Just when processed as a spray foam, and with simply and handy processing machines, this may lead to problems. Thus, for example, the high abrasiveness of these solids leads to a high extent of wear of the machine components, such as the pumps and mixing head. In addition, sedimentation problems may arise during the storage of the batch consisting of the reaction component and the solid. For example, if melamine is mixed into polyol without continuous stirring, the melamine will clump to form a solid, which can be removed from the storage tank only with difficulty.

Another problem is the high mechanical load on the solids employed that occurs, for example, during the processing in a high pressure mixing head. For example, if expandable graphite is sheared by such a high pressure mixing head at the valves and/or butterfly valves, the particles are disrupted and/or comminuted. This may result in a reduction of the flameproofing effect.

Therefore, it is the object of the present invention to provide a process, that enables flame-retarded PUR spray foams to be prepared, avoiding the drawbacks of the prior art. In particular, it is an object of the present invention to optimize the use of flame retardant solids, such as ammonium polyphosphate, melamine, expandable graphite, aluminum hydroxide or magnesium hydroxide, chalk, various cyanurates and/or glass flakes (hereinafter referred to as solids) as flame retardant agents in terms of quantities in such a way that a flameproofing effect is achieved especially in those regions of the polyurethane spray foam where such effect is required. This leads to a reduction of the required amount of solids. It is possible to use each of the solids individually or as mixtures thereof (combinations of solids). The process according to the invention for producing highly flameproof spray foams shows a possibility of utilizing the advantages of additionally used solid flame retardant agents while overcoming the above described drawbacks for the material, during the processing, and the possible reduction of the flameproofing effect.

In a first embodiment, the object of the invention is achieved by metering a solid or a mixture of different solids through a control unit into the compressed air used for producing the spray jet to the components into the reaction jet or the spray jet. By means of this device, a spray jet can be generated from the already mixed reaction mixture of polyol and isocyanate, and the solids employed.

In this way, an additional flameproofing material can be added to the previously employed polyurethane system, which does not mechanically affect the systems as described above on the one hand, and the solids employed are not damaged by shear forces from the pumps or the mixing head on the other. A thus modified polyurethane spray system can be classified in a higher fire protection class as compared to the comparably system lacking an additional solid fireproofing material.

Another advantage of the process according to the invention is the fact that the additional fireproofing effect from the solids employed can be placed exactly where it is needed, namely where a fire starts. In the regions not directly exposed to the fire, the concentration of flame retardant solids may be lower, or they may not be present at all, without having to change the composition otherwise of the polyurethane. At the same time, a good wetting of the solids with the reaction mixture is ensured.

Because of the fact that the additional metering of the solids into the air flow of the spray head can be controlled, a layer without additional solids can be applied first, and then the proportion of solids in every layer can be adjusted at will depending on requirements. In addition, it is also possible to provide the different layers with different solids and/or combinations of solids. A first layer without solids (facing towards the wall/ceiling) has the additional advantage that the adhesion of a polyurethane without fillers is usually better than that of a polyurethane enriched with fillers.

Further, experience/experiments with this new technology have shown that significantly higher amounts of solids can be processed as compared to a batch process. This may lead to classification of the PUR spray foam obtained into a higher fire protection class.

With the process according to the invention, it is possible to apply several layers, for example, to a wall and/or ceiling, wherein although the individual layers contain different amounts of incorporated flame retardant material, the compositions otherwise need not be different. In a process according to the invention, the ratio R of the amount of incorporated flame retardant material to the amount of the reaction mixture is constant within a defined time period, but is different from this ratio in a subsequent second time period. Thus, in the polyurethane spray foam body obtained, the proportion of the flame retardant material at the wall is different from the concentration in an opposing surface region.

“Proportion of the solid” as used herein means the mass and/or volume proportion of the solid in a defined, but variable volume, wherein two equally sized, but spatially non-overlapping volumes are compared for comparing the proportions.

For example, such a structure according to the invention causes an enrichment of the flame retardant solid in a surface region, namely the region exposed to a source of flames.

In a process according to the invention, a polyurethane foam without admixed flame retardants is first applied to a surface, for example, a wall and/or ceiling. In a next step, another PUR layer can be applied wet on wet. The latter layer also contains no or just a little flame retardant solids. Now, further PUR spray foam layers are applied, wherein the proportion of flame retardant solids or combinations of solids increases continuously or discontinuously from one layer to another. The outermost layer has the highest proportion of flame retardant solid. In an interior, for example, this layer may be covered by the plaster of the gypsum plaster board. If an apartment fire should occur, the highest proportion of flame retardant materials is now in the region where the source of flames is.

According to the invention, at least 2 layers are applied, one of the layers containing no flame retardant solids or combinations of solids while the other layer contains them. In particular, the layer that is directly applied to the surface, especially a wall and/or ceiling, is free from flame retardant solids or combinations of solids.

According to the invention, a comparable layer structure is also employed in the insulation of an outside wall of a house. In this case too, a polyurethane foam is applied in several layers to a surface, especially a wall. According to the invention, the layer applied first has no or just a little flame retardants. In the subsequent layers, the concentration of flame retardant agents may be higher than it is in the first layer. In particular, the outermost layer applied has the highest concentration of flame retardant solid or combination of solids. In order to ensure sufficient insulation, the entire layer should have a thickness of at least 3 cm, for example.

Depending on the specifications required from the resulting spray foam, when the various flame retardant solids are used, the flame retardants employed in conventional systems may be dispensed with, or their proportion significantly reduced. The omission of halogen-containing flame retardants is advantageous in view of the recent discussion about emissions in buildings.

In a process according to the invention, a component used for preparing a foam raw material is mixed with a liquid and/or solid flame retardant material or a mixture of flame retardant materials, and this mixture is reacted with the respective other reaction component and optionally further flame retardant materials or mixtures of solids to form a foam. The liquid and/or solid flame retardant material or mixture of flame retardant materials is incorporated in the foam raw material after the mixing of the reactive components, but before the spraying, and the thus obtained mixture is employed for forming a polyurethane molded foam.

According to the invention, the ratio R of the amount of incorporated flame retardant materials to the amount of the component/foam raw material is constant within a first defined time period, but is different from this ratio in a subsequent second time period.

The bulk density of a mixture of foam raw material and flame retardant material employed according to the invention is within a range of from 10 to 200 kg/m³, especially within a range of from 30 to 100 kg/m³.

Since the reaction mixture is preferably applied to walls or ceilings in a process according to the invention, it is important that a sufficiently quick build-up of viscosity is achieved. This can be achieved by appropriately setting the cream and setting times. Preferably, the cream time of the PUR reactive mixture is 2 s or longer. The setting time is within a range of from 3 to 20 sec, preferably from 4 to 8 sec.

A process according to the invention enables a large amount of solid to be added to the polyurethane. Preferably, the proportion of flame retardant solid in the reaction mixture is from 5 to 80% by weight, preferably from 5 to 50% by weight, more preferably from 10 to 30% by weight.

Another advantage of the process according to the invention is the fact that different particle sizes of the solids employed can be used. This also enables different flame retardants to be combined. In a case of fire, the danger of the produced gases can be reduced by appropriately selecting the flame retardants from combinations of liquid and solid components. For example, parameters like the flue gas density and flue gas toxicity can be adjusted more selectively thereby.

Since the flame retardant solids are employed only where they are needed in the process according to the invention, the total consumption of flame retardant agents is significantly reduced as compared to a batch process. This saves costs.

In another embodiment, the object of the invention is achieved by a polyurethane spray foam body in which the proportion of the flame retardant material increases continuously or discontinuously from one surface of the body towards the opposing surface of the body. This is enabled by the process described above.

In a third embodiment, the object of the present invention is achieved by the use of the polyurethane spray foam body according to the invention as a flame retardant heat insulation, especially in the construction of houses.

### EXAMPLES

The patterns according to the invention were prepared by spraying several layers of a rigid polyurethane foam system (polyol formulation A against isocyanate B). Thus, at first, a layer having a thickness of 12 to 18 mm of the reaction mixture having been admixed with additional solid flame retardant agent was sprayed onto a Teflon sheet. Then, in the next step, this first layer was again extended by another layer having a thickness of from 35 to 40 mm, this time without an additional solid flame retardant.

The output of the polyurethane spray unit in the production of the pattern panels was 20 g/s, and the solids were metered into the reaction mixture with an output of 10 g/s.

The surface produced during a spray process is typically very rough and uneven. Therefore, the pattern panel was subsequently cut to a total component height of 30 mm in thickness using a slitting line, in order to obtain both a more homogeneous/more planar surface in view of the fire test to be performed later, and to obtain a precisely defined layer thickness for the sake of reproducibility of the fire tests. This subsequent processing of the pattern panels is necessary here because the test panels must be adhesively bonded to standardized support plates in the fire tests to be performed. Therefore, this illustrative experimental set-up differs from the application example described above, i.e., the experimental set-up is exactly the opposite. However, this altered experimental set-up is necessary to be able to perform a reproducible fire test.

The rigid foam panels produced for the application examples contain different solid flame retardants. The following Table 1 shows a survey of the important experimental parameters:

TABLE 1

| | | | Com- |
|---|---|---|---|
| | | | parative |
| | Example 1 | Example 2 | Example 1 |
| Proportion of expandable graphite [%] | 25 | 25 | — |
| Proportion of aluminum hydroxide [%] | 20 | 20 | — |
| Proportion of ammonium polyphos- | — | 10 | — |
| phate [%] | | | |
| Proportion of XF 705-F [%] | — | — | — |
| Proportion of XF T 294 [%] | — | — | — |
| Proportion of Baylith powder [%] | — | — | — |
| Characteristic | 92.5 | 92.5 | 92.5 |
| (polyol A vs. isocyanate B) | | | |
| Mixing ratio [polyol:isocyanate] | 100:100.5 | 100:100.5 | 100:100.5 |
| Layer thickness of foam without | 13.05 | 15.05 | 30.0 |
| additional flame retardant [mm] | | | |
| Layer thickness of foam with | 15.55 | 14.2 | — |
| additional flame retardant [mm] | | | |
| Bulk density of foam without | 58.5 | 60 | 58 |
| additional flame retardant [kg/m³] | | | |
| Bulk density of foam with addi- | 77.5 | 82 | — |
| tional flame retardant [kg/m³] | | | |
| Bulk density of total foam [kg/m³] | 69.2 | 77.55 | 58 |

The thus prepared panels were sawed to two different final dimensions (1500×1500 mm and 1500×1000 mm), subsequently adhesively bonded to calcium silicate plates and preconditioned according to the testing protocol. Then, for the fire test, the two panels were placed upright with an angle of 90° between. Below, in the angle region of the two plates standing upright, an ignition flame is then applied.

The following Table 2 shows a survey of the results of the fire tests (SBI test and small flame test):

TABLE 2

| | | |
|---|---|---|
| | | Com- |
| | | parative |
| Example 1 | Example 2 | Example 1 |

SBI test according to EN 13823: 2002

| | | | |
|---|---|---|---|
| THR₆₀₀ [MJ] | 4.4 | 3.6 | 27.8 |
| FIGRA (0.2 MJ [W/s]) | 758 | 733 | 8331 |
| FIGRA (0.4 MJ [W/s]) | 586 | 449 | 8331 |
| TSP₆₀₀ [m²] | 127 | 105 | 666 |
| SMOGRA [m²/s²] | 229 | 276 | 2035 |
| SBI classification | D s3 d0 | D s3 d0 | D not |
| | | | reached, |
| | | | s3 d2 |

Small flame test according to EN ISO 11925-2: 2002

| | | | |
|---|---|---|---|
| Maximum flame | 60 | 50 | 170 |
| height (flame | | | |
| application: | | | |
| edge) [mm] | | | |
| Maximum flame | 63.3 | 60 | 150 |
| height (flame | | | |
| application: | | | |
| surface) [mm] | | | |
| Flaming droplets | no | no | no |
| Result | Requirements of | Requirements of | Require- |
| | fire class E are | fire class E are | ments of fire |
| | met, with approval | met, with approval | class F |
| | for EN 13823 | for EN 13823 | are met |

When the fire results of the comparative system without additionally metered flame retardant (Comparative Example 1) are compared with the results of Examples 1 and 2 according to the invention, it is clearly seen that the additional addition of flame retardant solids significantly improves the fire protection properties in the spray foam system employed.

Without additional flame retardant, fire class “F” is reached, while the addition of, in this case, expandable graphite and aluminum hydroxide enables a higher fire class to be reached, in this case classification “D”.

The further addition of ammonium polyphosphate (Example 2) shows that a positive influence on the fire behavior of the spray foam can be observed in this case too.

### Description of the Starting Materials:

### Individual Components of Polyol Formulation A:

Polyol 1: A commercially available aromatic polyester with an OH number of about 161 and a functionality of 2.
Polyol 2: A commercially available trifunctional PO polyether with an OH number of 231.
Polyol 3: A commercially available Mannich base with an OH number of about 560.
Stabilizer: Polyether-modified polysiloxane from the company Evonik Goldschmidt GmbH.

Mixture of activators consisting of: N,N-dimethylethanolamine (e.g., from the company RheinChemie), pentamethyldiethylenetriamine (e.g., from the company Air Products), tris(3-dimethylamino)propylamine (e.g., Polycat 9 from the company Air Products), and dibutyltin dilaurate (e.g., Niax Catalyst T 12 from the company Air Products).

Mixture of liquid flame retardants: trichloropropyl phosphate (e.g., Levagard PP from the company RheinChemie), and triethyl phosphate (e.g., Levagard TEP from the company Lanxess).

Mixture of physical blowing agents: 1,1,1,3,3-pentafluoropropane (e.g., Enovate 3000 from the company Honeywell), and pentafluorobutane/heptafluoropropane (e.g., Solkane 365/227 93/7 from the company Solvay).

### Polyisocyanate B:

A polymeric isocyanate with an NCO content of about 31.5, prepared on the basis of 2-ring MDIs and their higher homologs.

Formulation of Polyol Formulation “A”:

| | Formulation of rigid spray foam |
|---|---|
| Polyol 1 | 39.72 |
| Polyol 2 | 9.69 |
| Polyol 3 | 16.47 |
| Water | 2.83 |
| Stabilizer | 0.49 |
| Mixture of activators | 4.94 |
| Mixture of liquid flame retardants | 15.12 |
| Mixture of physical blowing agents | 10.74 |
| Polyisocyanate at characteristic of 92.5 | 89.69 |

as expandable graphite, there was employed: “Expofoil PX 99” from the company Georg H. LUH GmbH
as aluminum hydroxide, there was employed: “Martinal ON 320” from the company Alusuisse Martinswerk GmbH
as ammonium polyphosphate, there was employed: “Exolit AP 422” from the company Clariant

1. A process for producing flameproof rigid PUR spray foams, in which a liquid and/or solid flame retardant material or mixtures thereof are incorporated in a reaction mixture of polyol component and isocyanate component, the thus obtained mixture is employed for forming a spray rigid foam body, characterized in that at least one flame retardant material or a mixture of flame retardant materials is metered through a control unit into the reaction jet before a spray jet is formed.

2. The process for producing flameproof PUR spray foams according to claim 1, characterized in that the ratio R of the amount of incorporated flame retardant material(s) to the amount of the reaction mixture is constant within a defined time period, but is different from this ratio in a subsequent second time period.

3. The process for producing flameproof PUR spray foams according to claim 1, characterized in that
at least one liquid and/or solid flame retardant material is mixed with a component selected from polyol and isocyanate used for producing a foam raw material, and the mixture is reacted with the respective other reaction component to form the foam raw material, and
at least one liquid and/or solid flame retardant material is incorporated in the foam raw material,
the thus obtained mixture is employed for forming the polyurethane molded foam body, wherein the ratio R of the amount of incorporated flame retardant material(s) to the amount of the component/foam raw material is constant within a first defined time period, but is different from this ratio in a subsequent second time period.

4. The process for producing flameproof PUR spray foams according to claim 1, characterized in that said at least one flame retardant material and said foam raw material are sprayed onto a wall and/or ceiling.

5. The process for producing flameproof PUR spray foams according to claim 4, characterized in that said foam raw material without or with a low proportion of flame retardant material is first applied to a wall and/or ceiling, and then the flame retardant material and the foam raw material are applied.

6. The process according to any of claims 1 to 5, characterized in that the bulk density of the mixture of foam raw material and flame retardant material employed for the application is adjusted within a range of from 10 to 200 kg/m³, especially within a range of from 30 to 100 kg/m³.

7. The process according to any of claims 1 to 6, characterized in that the polyol component and isocyanate are selected in such a way that the cream time of the PUR reactive mixture is 2 seconds or longer, and the setting time is within a range of from 3 to 10 seconds, especially 5 seconds.

8. The process according to any of claims 1 to 7, characterized in that the amount of flame retardant solid supplied is adjusted within a range of from 5 to 80% by weight, preferably from 5 to 50% by weight, more preferably from 10 to 30% by weight, based on the total system.

9. The process according to any of claims 1 to 8, characterized in that expandable graphite, ammonium polyphosphates, cyanurates, aluminum hydroxide, magnesium hydroxide, melamine and/or glass flakes including mixtures thereof are employed as said flame retardant solid.

10. A polyurethane spray foam body prepared by a process according to any of claims 1 to 9, characterized in that the proportion of a flame retardant solid in a surface region adjacent to the wall is lower than the proportion of said flame retardant solid in a remote surface region.

11. The polyurethane spray foam body according to claim 10, characterized in that the proportion of the flame retardant material increases continuously or discontinuously from one surface of the body towards the opposing surface of the body.

12. Use of a polyurethane spray foam body prepared according to any of claims 1 to 9 as a flame retardant heat insulation.
